(19) United States
(12) Patent Application Publication
(10) Pub. No.: US 2024/0338723 A1
(43) Pub. Date: Oct. 10, 2024

(54) SYSTEMS AND METHODS FOR MULTI-PARTY TRANSACTIONS

(71) Applicant: Datum Point Labs Inc., Jackson, WY (US)

(72) Inventor: Patrick Nunally, San Diego, CA (US)

(21) Appl. No.: 18/627,298

(22) Filed: Apr. 4, 2024

Related U.S. Application Data
(60) Provisional application No. 63/457,686, filed on Apr. 6, 2023.

(51) Int. Cl. G06Q 30/0207; G06Q 20/24; G06Q 20/38

(52) U.S. Cl. CPC G06Q 30/0207; G06Q 20/24; G06Q 20/38215

(57) ABSTRACT

Embodiments described herein provide systems and methods for multi-party transactions. A user device may receive offers for conditional credits from an offering device, based on user information. The user device may accept the offer, which causes the offering device to add the conditional credit to a digital ledger. The conditional credit may then be used in a transaction where the issuing bank fulfils a portion of the transaction and the remaining portion of the transaction is fulfilled by the conditional credit (when the criteria of the conditional credit are met).

### CROSS REFERENCE(S)

The instant application is a nonprovisional of and claim priority under 35 U.S.C. 119 to U.S. provisional application No. 63/457,686, filed Apr. 6, 2023, which is hereby expressly incorporated by reference herein in its entirety.

### TECHNICAL FIELD

The embodiments relate generally to systems and methods for multi-party transactions.

### BACKGROUND

Payment systems allow for two-party transactions to occur, where a party uses their debit or credit card at a payment device, the card information is sent to a bank, and the entire transaction is resolved and recorded. In some instances, there is a desire to include a third party in a transaction. For example, in order to incentivize certain behavior, a third party may offer to pay for a portion of a transaction. Existing methods, however, rely on the receiving party to handle any sort of third-party interaction such as handling coupons etc. by materially altering the point of sale. Therefore, there is a need for improved systems and methods for multi-party transactions.

### BRIEF DESCRIPTION OF THE DRAWINGS

FIG. 1 illustrates a framework for multi-party transactions, according to some embodiments.

FIG. 2 is a simplified diagram illustrating a computing device implementing the framework described herein, according to some embodiments.

FIG. 3 is a simplified diagram illustrating a neural network structure, according to some embodiments.

FIG. 4 is a simplified block diagram of a networked system suitable for implementing the framework described herein.

FIGS. 5A-5C are example logic flow diagrams, according to some embodiments.

FIGS. 6A-6B are exemplary devices with digital avatar interfaces, according to some embodiments.

### DETAILED DESCRIPTION

Payment systems allow for two-party transactions to occur, where a party uses their debit or credit card at a payment device, the card information is sent to a bank, and the entire transaction is resolved and recorded. In some instances, there is a desire to include a third party in a transaction. For example, in order to incentivize certain behavior, a third party may offer to pay for a portion of a transaction. Existing methods, however, rely on the receiving party to handle any sort of third-party interaction such as handling coupons etc. by materially altering the point of sale.

In view of the need for improved systems and methods for multi-party transactions, embodiments herein provide for multi-party transactions without requiring additional setup by the receiving party. Embodiments herein allow multiple parties to collectively secure, service and transact a multiparty and multifaceted transactions without materially altering points of sale or the seller or user's perceptions of a single timely transaction. In some embodiments, a ledger of transactions is kept via blockchain technology.

As a branch of blockchain technology, consortium blockchain technology is increasingly used. Secure ledger nodes in a consortium blockchain network include service nodes and consensus nodes. The service node participates in a service, and the consensus node is responsible for receiving service data sent by the service node and performing consensus verification on the service data.

The previously described service node is a service server of each institution that joins the consortium blockchain network, and software is installed on the server to communicate with another node in the consortium blockchain network (the software is referred to as a “communication program” in the present application).

Different service nodes provide services for different applications (APPs). The service node sends service data generated by the APP to the consensus node for consensus verification. Assuming that a service node is a server corresponding to a commerce application, another service node is a server corresponding to a payment application. In the current art, a user can make a payment through the payment application after placing an order through the commerce application, as such, the two service nodes participate in the same service, and can register a service relationship with the consortium blockchain network.

One or more implementations of the present application provide a secure ledger hashing structure implemented to act at the edge on a resolved secure contract system and method, to resolve a problem, in the existing technology, of one-to-one transaction and computation as well as infrastructural delays in single party transaction service end points, channels, servers as well as transitional data held in any communication network devices.

One or more embodiments provide: an edge node communications apparatus, a local secure ledger to resolve an immediate transaction participation.

In some embodiments, systems described herein employ secure ledger technology in a unique way resulting in unexpected and highly desirable results. Embodiments include a decentralized communication system, method and apparatus to and provide a local edge secure ledger providing local multiple stakeholder transaction support and secure, timely transactions across payment processing networks or simply payment networks. Embodiments described herein facilitate the transfer of information and funds sourced from a local secure ledger between the merchant's credit card reader or point-of-sale (POS) terminal and the customer's issuing bank or card association and a multiplicity of customer's issuing credits. where an exemplary embodiment is illustrated in terms of a gas pump point of sale platform.

Embodiments described herein use a unique edge secure ledger which is used to package multiparty participation and credentials to transactions executed over existing payment processing networks. While transactions on existing payment networks facilitate the transfer of information and funds between the merchant's credit card reader or point-of-sale (POS) terminal and the customer's issuing bank or card association the new technology presented herein inserts a local edge Service Node secure ledger to embed two or more sources of funds into single transaction processes allowing users and monitory repositories on wired or wireless networks to concatenate hashing to a single exchanged message across an existing payment network without needing secondary to tertiary network participation by the merchant or merchant systems. Embodiments described herein run on the common systems such as (but not limited to) the Mastercard payment processing network, Hyperlink Burrow blockchain (IBM/EVM) and Apple secure digital wallet and solves the core issues or metapayment problem by allowing users to communicate solely through preset payment processing networks using standard wallet address protocols while seamlessly supporting the plurality of payment sources as part of the single transaction. This allows for the use of a pre-distributed conditional funds sources to fulfill local edge ledgers within with full ethernet 10/100, WiFi 7 and 4/5G data speeds, end to end encryption (where data remains fully encrypted at rest), end point access to edge ledger is locked via bioinfometrics as well as traditional multifactor authentication.

The new technology disclosed herein maintains encryption of all data (even data at rest/storage), maintains data integrity and distinctively integrates multiple parties into payment information and user transaction timing through an application of edge secure ledgers which affect dynamic party consortia in what presents to the payment processor as a single transaction between a point of sale and payment processor using an edge secure ledger system.

Embodiments described herein support secure edge amalgamation of multiple stakeholders in common translation supported by existing, transport, processing, storage and remote access systems. Embodiments described herein support sub second data access via local edge secure ledger infrastructures. Embodiments described herein minimize effective transaction time, latency and memory requirements. Embodiments described herein are compatible with existing payment processing, decentralized and/or centralized networks server clusters.

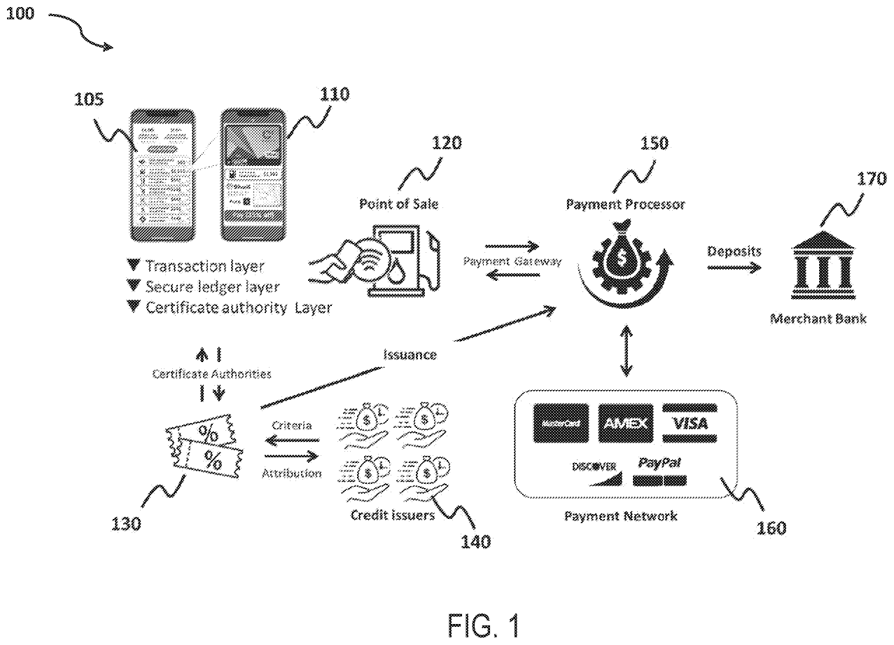

FIG. 1 illustrates an exemplary framework 100 for multi-party transactions, according to some embodiments. Framework 100 illustrates a point of sale 120 in communication with a merchant bank 170 and a payment network 160 via a payment processor 150. When a user presents a payment card or digital payment device (e.g., a smart phone configured for payments) at the point of sale 120, point of sale 120 requests an authorization from payment network 160 via payment processor 150. For example, at the exemplary gas pump, an authorization may be requested for an estimated $75 to ensure that the user has sufficient funds before beginning to pump gas. If the card is legitimate and there are sufficient funds, payment network 160 transmits and authorization back to point of sale 120. After point of sale 120 determines the final amount (e.g., the cost of gas actually pumped), point of sale 120 “captures” the funds by sending a request to payment network 160 to transfer the appropriate funds from payment network 160 to merchant bank 170. The transfer request is associated with the prior authorization via an authorization code. The actual transfer of funds to merchant bank 170 may occur at a later time, known as “settlement.” In some embodiments, actions described herein as being performed by a payment network 160 may be performed directly by an issuing bank (not illustrated). For example, an issuing bank may receive authorization requests, check the validity of a payment method and the sufficiency of funds, and accordingly send an authorization code to point of sale 120 or payment processor 150, etc. Further, in some embodiments, point of sale 120 communicates directly with a merchant bank 170, payment network 160, and/or issuing bank without a payment processor 150 intermediary.

In some embodiments, a third party may be included in a transaction via a conditional credit 130. A conditional credit 130 may be an entity in a ledger that tracks a credit with corresponding limitations on the use of the credit. For example, a conditional credit 130 may identify a $2 credit that may be used toward the purchase of gas from a gas station. The types of limitations may include a number of things, including limitations on time, location, specific vendors, type of item or service being purchased, time between uses, etc. In an example, a conditional credit 130 may include a credit that is only able to be used in the purchase of food, for example as part of a food assistance program. In another example, the conditional credit 130 may only allow medical-related purchases. In another example, a conditional credit 130 may only allow certain travel-related expenses (e.g., hotel, flight, vehicle rentals/rideshares, meals). A credit issuer 140 may, for example, utilize one or more conditional credits as a method for pre-authorizing travel expenses without requiring a user to keep receipts and get refunded for travel expenses. Limits may be provided for different categories (e.g., a limit for transportation expenses, limits for individual meals based on time of day etc.).

Credit issuers 140 may provide conditional credits with associated limitations (i.e., criteria) to specific users. A user may use an application 105, for example on a mobile device, to view available conditional credits and their limitations/criteria, and authorize the use of a conditional credit. In some embodiments, when selecting a particular conditional credit, the user may be presented with additional information and/or the ability to confirm the use of the conditional credit via a confirmation screen 110. In some embodiments, the application 105 may present offers to a user, and the selection of the offer by the user causes credit issuer to issue the associated conditional credit 130 to the user. In other words, the ledger may not include a conditional credit 130 for the user until the user requests the conditional credit via application 105. For example, a user device may present, via a user interface, the availability of a conditional credit with a criteria that it may be used towards the purchase of gas from a particular gas station. The user may select the conditional credit and request/authorize its use before, during, or shortly after a transaction.

In some embodiments, a credit issuer 140 may offer or provide conditional credits 130 based on a number of criteria. For example, credit issuer 140 may receive user-specific information such as historical behaviors, location, identifying information such as age and gender, learned preferences, etc. The information may be used in determining what conditional credits and/or credits to provide to the user. The determination may also be based on information that is not user-specific such as weather information, statistical information on utilization of previously provided conditional credits, etc. In some embodiments, the determination to offer a conditional credit is determined using a neural network based model. For example, a model may be provided with one or more pieces of information as described above, and provide a recommended credit, associated criteria, etc. as an output. In response to the output, credit issuer 140 may present the offered conditional credit to the user via user interface 105. In an example, a model may be provided the location of a user and weather information associated with the user's location. The model may determine to offer the user a $1 credit toward the purchase of ice cream at a store that is nearby to the user as a result. The offer may be presented via user interface 105. In some embodiments, the amount of credit may be variable, and different users may be offered different amounts based on the determination of the model. In some embodiments, rather than a neural network based model, a rules-based algorithm may be configured. For example, a geographic area may be configured such that a user entering the area may be offered the credit (e.g., for a store in the area).

When the user makes a purchase using point of sale 120, the point of sale 120 does not need to have any knowledge of the credit, but rather treats the purchase as a regular purchase. The point of sale 120 requests an authorization from payment network 160 via payment processor 150. Payment network 160 in addition to sending an authorization code to point of sale 120, also sends the authorization code to a certificate authority (e.g., payment processor 150 or other system). In some embodiments, the certificate authority determines if a conditional credit is able to be used in a purchase by checking the associated credit and criteria. In some embodiments, the ledger is a smart ledger that provides an automatic process such that an attempt to utilize a credit is only successful when the criteria is met. In some embodiments, an authorization code is not sent to another system, but rather payment network 160 may check against the ledger to determine if a credit is able to be used in a purchase. The payment network 160 may perform the check against a ledger itself, or may rely on an intermediary processing server. As described below, the ledger may be built on a blockchain network. User authorizations of conditional credits may be included in the ledger itself associated with the conditional credit, and/or may be communicated to payment network by other means.

In some embodiments, payment network 160 determines the status of a conditional credit 130 before determining to send an authorization code to point of sale 120, in this way it may authorize amounts greater than is available for a payment method if the difference is available from the conditional credit 130. Point of sale 120 may send a transfer request (i.e., capture) associated with the authorization code. The transfer request may be fulfilled partially by payment network 160, and partially by a conditional credit 130. If the transaction expends all of the credits for conditional credit 130, the conditional credit 130 may be removed from the ledger. In some cases, only a portion of an available credit for a conditional credit 130 is used, and the credit amount remaining is recorded in the ledger. Payment processor 150 may be configured to receive conditional credit 130 information such that payment processor 150 is able to transfer funds from the conditional credit (e.g., by updating the ledger) and from payment network 160 to merchant bank 170. Payment processor 150 may determine whether the criteria of a conditional credit 130 is met based on information from point of sale 120. For example, if point of sale 120 is associated with a specific gas station, and the criteria for a conditional credit 130 is that the credit be used at a different gas station, payment processor 150 may not utilize the credit.

In some embodiments, the “capture” stage may utilize funds from payment network 160 without any credit from a conditional credit 130. In this case, at or before settlement occurs, payment processor 150 may settle the funds using funds from both payment network 160 and a conditional credit 130. To point of sale 120, it appears the same as a normal purchase, but instead of the full funds being taken from payment network 160, it is partially fulfilled by conditional credit 130. The time between capturing and settling allows for flexibility in the timing of how certain actions are performed. For example, in some embodiments, a user may authorize the use of a conditional credit 130 after making a purchase but before settlement. In some embodiments, an adjustment may be made to the transferred amount, for example a tip being added after payment.

Embodiments herein include local dynamic nodes in a secure ledger network including an edge ledger node. The edge ledger node may be a device situated at the edge of the network or system architecture (e.g., a user device, computer, server, etc.). The edge ledger node is responsible for entering block registries of ledger-related operations, which include recording and validating transactions, maintaining the distributed ledger, and facilitating communication between different parts of the network. The edge ledger node stores one or more certificates sent by a certificate authority (CA), and is pre-configured with a CA trust list. The certificate authority is the entity responsible for issuing digital certificates, which are used to verify the authenticity of identities and secure communication over the network. In some embodiments, the certificate authority may be a separate device on the network not shown in FIG. 1. In some embodiments, the certificate authority may be integrated with a trust list within the system architecture. In some embodiments, the functionality of a certificate authority may be performed by a credit issuer 140, payment processor 150, or other device. The method includes: receiving, by a first secure ledger node, a communication request sent by a secure ledger node, where the communication request includes a wallet certificate of the second secure ledger node; determining a CA identifier that corresponds to the second certificate; determining whether the determined CA identifier that corresponds to the wallet certificate is included in the CA trust list; and if yes, establishing a local secure ledger entry to the second edge ledger node registry; or if unsupported, skipping establishing the local secure ledger entry to the second edge ledger node registry.

An edge secure ledger node enabled communication apparatus is provided, and the apparatus includes: a receiving module, configured to receive a communication request sent by an edge secure ledger node, where the communication request includes a wallet conditional credit 130 of the edge secure ledger node; a determining module, configured to determine a CA identifier that corresponds to the edge secure ledger node and a determining and execution module, configured to determine whether the determined CA identifier that corresponds to the wallet conditional credit 130 is included in a CA trust list; and if yes, establish a communication connection to the edge secure ledger node; or if no, skip establishing the communication connection to the edge secure ledger node; where said first secure ledger node in a secure ledger network include a service node, and the service node stores a conditional credit 130 sent by a CA, and is pre-configured with the CA trust list.

An edge secure ledger node operating in association with a communications device is provided. The communications device includes one or more processors and a memory. The memory stores a program, and the program is executed by the one or more processors to perform the following steps: receiving, at a first secure ledger node, a communication request sent by a second secure ledger, where the credit request or offer includes a wallet conditional credit 130 of the second secure ledger node; determining a CA identifier that corresponds to the second conditional credit 130; determining whether the determined CA identifier that corresponds to the wallet conditional credit 130 is included in a CA trust list; and if yes, establishing a communication connection to the second secure ledger node and encoding of the CA; or if no, skipping establishing the communication connection to the second secure ledger node; where secure ledger nodes in a multi-stakeholder transaction network includes one or more service node, and the one or more service node stores a conditional credit 130 sent by a CA, and is pre-configured with the CA trust list.

In some embodiments, an edge service node in a multistakeholder transaction network stores one or more certificates 130 sent by a CA, and is preconfigured with a CA trust list. When receiving the communication request sent by the second secure ledger node, the first secure ledger node can first determine, based on the wallet conditional credit 130 of the second secure ledger node that is included in the communication request, the CA identifier that corresponds to the second conditional credit 130, and then determine whether the CA identifier that corresponds to the wallet conditional credit 130 is included in the CA trust list. If yes, the first secure ledger node establishes the communication connection to the second secure ledger node; or if no, the first secure ledger node does not establish the communication connection to the second secure ledger node. According to the method provided in the implementations of the present application, before establishing a communication connection, the service node in the blockchain network can determine whether to establish the communication connection based on the pre-configured CA trust list and a conditional credit 130 that is included in a communication request, so that a possibility of leaking privacy data by the service node can be reduced by limiting an object (for example, another service node) to which the service node can establish the communication connection, and security of data stored in the blockchain network is improved.

In some implementations, steps may be performed before the communication session is established between the point of sale 120 and the payment processor 150. For example, payment processor 150 that has initiated the communication request may also wish to perform a reciprocal identity verification of the point of sale 120 prior to establishing the communication session between the two nodes (point of sale 120 and payment processor 150). Such mutual verification of identity may improve overall security of the blockchain network. As such, in some implementations, the payment processor 150 includes a second CA trust list comprising a plurality of CA identifiers 130, and approving, by the point of sale 120, the communication request comprises: transmitting, by the point of sale 120 to the payment processor 150, a verification request comprising a public key certificate of the point of sale 120. The verification request, for example, can be transmitted in accordance with communication protocols such as the SET, TLS or SSL protocol. In such implementations, framework 100 further comprises: determining, by the payment processor 150, a second CA identifier from the received public key certificate of the point of sale 120; determining whether the second CA identifier matches one of the plurality of CA identifiers of the second CA trust list of the payment processor 150; in response to determining that the second CA identifier matches one of the plurality of CA identifiers of the second CA trust list, establishing a communication session with the point of sale 120; and in response to determining that the second CA identifier does not match one of the plurality of CA identifiers of the second CA trust list, denying, by the payment processor 150, establishment of the communication session with the point of sale 120.

The methods and apparatuses disclosed herein improves security and enablement of multiparty transactions, mitigate transaction fraud and allow multiple stakeholders to participate in uniform transactions supported by transaction network infrastructure. By denying establishment of communication sessions with nodes whose identities are not certified by a trusted CA, security of the nodes of a consortium transaction stakeholders can be achieved over nodes that do not utilize a CA trust list. Further, performance of the secure multiparty, multifactor network implementing the disclosed methods and apparatuses are superior to performance of conventional 2 factor stakeholder participation due to the reduced processing time associated with verification of the chain of trust and functional transparency to user.

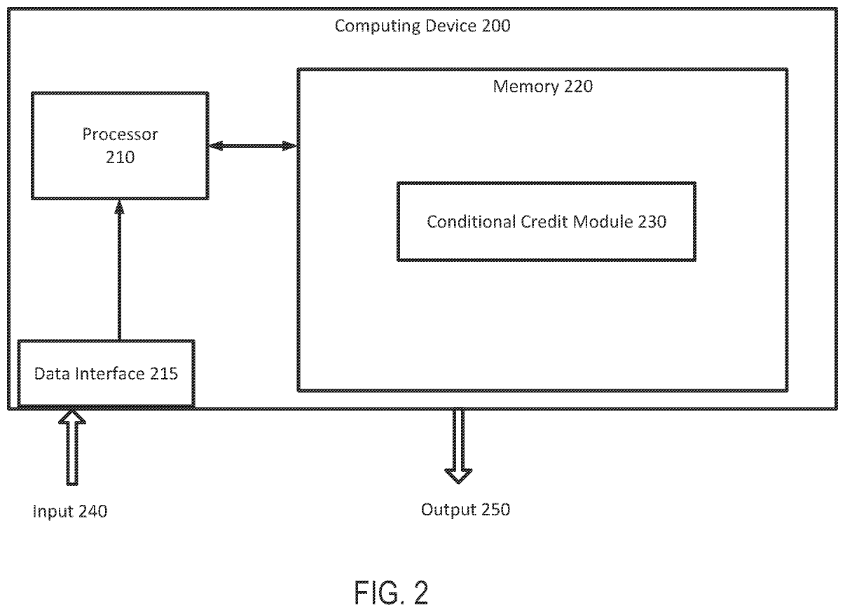

FIG. 2 is a simplified diagram illustrating a computing device 200 implementing the framework described herein, according to some embodiments. As shown in FIG. 2, computing device 200 includes a processor 210 coupled to memory 220. Operation of computing device 200 is controlled by processor 210. And although computing device 200 is shown with only one processor 210, it is understood that processor 210 may be representative of one or more central processing units, multi-core processors, microprocessors, microcontrollers, digital signal processors, field programmable gate arrays (FPGAs), application specific integrated circuits (ASICs), graphics processing units (GPUs) and/or the like in computing device 200. Computing device 200 may be implemented as a stand-alone subsystem, as a board added to a computing device, and/or as a virtual machine.

Memory 220 may be used to store software executed by computing device 200 and/or one or more data structures used during operation of computing device 200. Memory 220 may include one or more types of transitory or non-transitory machine-readable media (e.g., computer-readable media). Some common forms of machine-readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Processor 210 and/or memory 220 may be arranged in any suitable physical arrangement. In some embodiments, processor 210 and/or memory 220 may be implemented on a same board, in a same package (e.g., system-in-package), on a same chip (e.g., system-on-chip), and/or the like. In some embodiments, processor 210 and/or memory 220 may include distributed, virtualized, and/or containerized computing resources. Consistent with such embodiments, processor 210 and/or memory 220 may be located in one or more data centers and/or cloud computing facilities.

In some examples, memory 220 may include non-transitory, tangible, machine readable media that includes executable code that when run by one or more processors (e.g., processor 210) may cause the one or more processors to perform the methods described in further detail herein. For example, as shown, memory 220 includes instructions for certificate module 230 that may be used to implement and/or emulate the systems and models, and/or to implement any of the methods described further herein.

Conditional credit Module 320 may be configured to perform the actions as described herein. For example, conditional credit module 230 may receive input 240 such as conditional credit information including criteria and credit amounts, etc. and generate an output 250 such as an authorization for a credit, etc.

The data interface 215 may comprise a communication interface, a user interface (such as a voice input interface, a graphical user interface, and/or the like). For example, the computing device 200 may receive the input 240 from a networked device via a communication interface. Or the computing device 200 may receive the input 240, such as an indication that a user would like to use a conditional credit, from a user via the user interface.

Some examples of computing devices, such as computing device 200 may include non-transitory, tangible, machine readable media that include executable code that when run by one or more processors (e.g., processor 210) may cause the one or more processors to perform the processes of method. Some common forms of machine-readable media that may include the processes of method are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

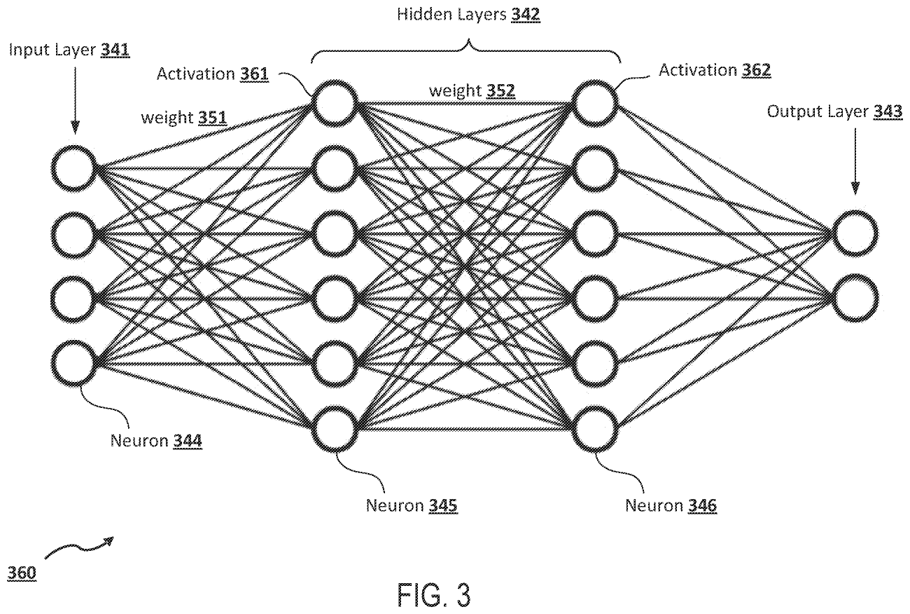

FIG. 3 is a simplified diagram illustrating the neural network structure, according to some embodiments. In some embodiments, the conditional credit module 230 may be implemented at least partially via an artificial neural network structure shown in FIG. 3. The neural network comprises a computing system that is built on a collection of connected units or nodes, referred to as neurons (e.g., 344, 345, 346). Neurons are often connected by edges, and an adjustable weight (e.g., 351, 352) is often associated with the edge. The neurons are often aggregated into layers such that different layers may perform different transformations on the respective input and output transformed input data onto the next layer.

For example, the neural network architecture may comprise an input layer 341, one or more hidden layers 342 and an output layer 343. Each layer may comprise a plurality of neurons, and neurons between layers are interconnected according to a specific topology of the neural network topology. The input layer 341 receives the input data such as training data, user input data, vectors representing latent features, etc. The number of nodes (neurons) in the input layer 341 may be determined by the dimensionality of the input data (e.g., the length of a vector of the input). Each node in the input layer represents a feature or attribute of the input.

The hidden layers 342 are intermediate layers between the input and output layers of a neural network. It is noted that two hidden layers 342 are shown in FIG. 3 for illustrative purpose only, and any number of hidden layers may be utilized in a neural network structure. Hidden layers 342 may extract and transform the input data through a series of weighted computations and activation functions.

For example, as discussed in FIG. 2, the conditional credit module 230 receives an input 240 and transforms the input into an output 250. To perform the transformation, a neural network such as the one illustrated in FIG. 3 may be utilized to perform, at least in part, the transformation. Each neuron receives input signals, performs a weighted sum of the inputs according to weights assigned to each connection (e.g., 351, 352), and then applies an activation function (e.g., 361, 362, etc.) associated with the respective neuron to the result. The output of the activation function is passed to the next layer of neurons or serves as the final output of the network. The activation function may be the same or different across different layers. Example activation functions include but not limited to Sigmoid, hyperbolic tangent, Rectified Linear Unit (ReLU), Leaky ReLU, Softmax, and/or the like. In this way, after a number of hidden layers, input data received at the input layer 341 is transformed into rather different values indicative data characteristics corresponding to a task that the neural network structure has been designed to perform.

The output layer 343 is the final layer of the neural network structure. It produces the network's output or prediction based on the computations performed in the preceding layers (e.g., 341, 342). The number of nodes in the output layer depends on the nature of the task being addressed. For example, in a binary classification problem, the output layer may consist of a single node representing the probability of belonging to one class. In a multi-class classification problem, the output layer may have multiple nodes, each representing the probability of belonging to a specific class.

Therefore, the conditional credit module 230 may comprise the transformative neural network structure of layers of neurons, and weights and activation functions describing the non-linear transformation at each neuron. Such a neural network structure is often implemented on one or more hardware processors 210, such as a graphics processing unit (GPU).

In one embodiment, the conditional credit module 230 may be implemented by hardware, software and/or a combination thereof. For example, the conditional credit module 230 may comprise a specific neural network structure implemented and run on various hardware platforms 360, such as but not limited to CPUs (central processing units), GPUs (graphics processing units), FPGAs (field-programmable gate arrays), Application-Specific Integrated Circuits (ASICs), dedicated AI accelerators like TPUs (tensor processing units), and specialized hardware accelerators designed specifically for the neural network computations described herein, and/or the like. Example specific hardware for neural network structures may include, but not limited to Google Edge TPU, Deep Learning Accelerator (DLA), NVIDIA AI-focused GPUs, and/or the like. The hardware 360 used to implement the neural network structure is specifically configured based on factors such as the complexity of the neural network, the scale of the tasks (e.g., training time, input data scale, size of training dataset, etc.), and the desired performance.

In one embodiment, the neural network based conditional credit module 230 may be trained by iteratively updating the underlying parameters (e.g., weights 351, 352, etc., bias parameters and/or coefficients in the activation functions 361, 362 associated with neurons) of the neural network based on a loss function. For example, during forward propagation, the training data such as user information are fed into the neural network. The data flows through the network's layers 341, 342, with each layer performing computations based on its weights, biases, and activation functions until the output layer 343 produces the network's output 350. In some embodiments, output layer 343 produces an intermediate output on which the network's output 350 is based.

The output generated by the output layer 343 is compared to the expected output (e.g., a “ground-truth” such as the corresponding conditional credit information) from the training data, to compute a loss function that measures the discrepancy between the predicted output and the expected output. Given a loss function, the negative gradient of the loss function is computed with respect to each weight of each layer individually. Such negative gradient is computed one layer at a time, iteratively backward from the last layer 343 to the input layer 341 of the neural network. These gradients quantify the sensitivity of the network's output to changes in the parameters. The chain rule of calculus is applied to efficiently calculate these gradients by propagating the gradients backward from the output layer 343 to the input layer 341.

Parameters of the neural network are updated backwardly from the last layer to the input layer (backpropagating) based on the computed negative gradient using an optimization algorithm to minimize the loss. The backpropagation from the last layer 343 to the input layer 341 may be conducted for a number of training samples in a number of iterative training epochs. In this way, parameters of the neural network may be gradually updated in a direction to result in a lesser or minimized loss, indicating the neural network has been trained to generate a predicted output value closer to the target output value with improved prediction accuracy. Training may continue until a stopping criterion is met, such as reaching a maximum number of epochs or achieving satisfactory performance on the validation data. At this point, the trained network can be used to make predictions on new, unseen data, such as determining a recommended conditional credit.

Neural network parameters may be trained over multiple stages. For example, initial training (e.g., pre-training) may be performed on one set of training data, and then an additional training stage (e.g., fine-tuning) may be performed using a different set of training data. In some embodiments, all or a portion of parameters of one or more neural-network model being used together may be frozen, such that the “frozen” parameters are not updated during that training phase. This may allow, for example, a smaller subset of the parameters to be trained without the computing cost of updating all of the parameters.

The neural network illustrated in FIG. 3 is exemplary. For example, different neural network structures may be utilized, and additional neural-network based or non-neural-network based component may be used in conjunction as part of module 230. For example, a text input may first be embedded by an embedding model, a self-attention layer, etc. into a feature vector. The feature vector may be used as the input to input layer 341. Output from output layer 343 may be output directly to a user or may undergo further processing. For example, the output from output layer 343 may be decoded by a neural network based decoder. The neural network illustrated in FIG. 300 and described herein is representative and demonstrates a physical implementation for performing the methods described herein.

Through the training process, the neural network is “updated” into a trained neural network with updated parameters such as weights and biases. The trained neural network may be used in inference to perform the tasks described herein, for example those performed by module 230. The trained neural network thus improves neural network technology in multi-party transactions.

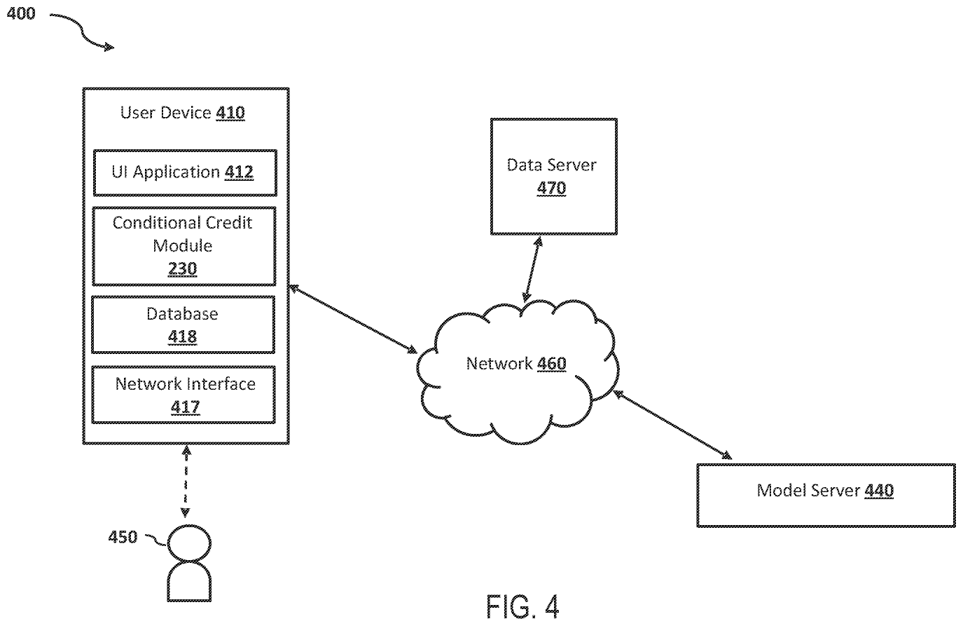

FIG. 4 is a simplified block diagram of a networked system 400 suitable for implementing the framework described herein. In one embodiment, system 400 includes the user device 410 (e.g., computing device 200) which may be operated by user 450, data server 470, model server 440, and other forms of devices, servers, and/or software components that operate to perform various methodologies in accordance with the described embodiments. Exemplary devices and servers may include device, stand-alone, and enterprise-class servers which may be similar to the computing device 200 described in FIG. 2, operating an OS such as a MICROSOFT® OS, a UNIX® OS, a LINUX® OS, a real-time operation system (RTOS), or other suitable device and/or server-based OS. It can be appreciated that the devices and/or servers illustrated in FIG. 4 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entities. In some embodiments, user device 410 is used in training neural network based models. In some embodiments, user device 410 is used in performing inference tasks using pre-trained neural network based models (locally or on a model server such as model server 440).

User device 410, data server 470, and model server 440 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 400, and/or accessible over network 460. User device 410, data server 470, and/or model server 440 may be a computing device 200 (or similar) as described herein.

In some embodiments, all or a subset of the actions described herein may be performed solely by user device 410. In some embodiments, all or a subset of the actions described herein may be performed in a distributed fashion by various network devices, for example as described herein.

User device 410 may be implemented as a communication device that may utilize appropriate hardware and software configured for wired and/or wireless communication with data server 470 and/or the model server 440. For example, in one embodiment, user device 410 may be implemented as an autonomous driving vehicle, a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data, such as an IPAD® from APPLE®. Although only one communication device is shown, a plurality of communication devices may function similarly.

User device 410 of FIG. 4 contains a user interface (UI) application 412, and conditional credit module 230, which may correspond to executable processes, procedures, and/or applications with associated hardware. For example, the user device 410 may allow a user to use a third-party credit service. In other embodiments, user device 410 may include additional or different modules having specialized hardware and/or software as required.

In various embodiments, user device 410 includes other applications as may be desired in particular embodiments to provide features to user device 410. For example, other applications may include security applications for implementing client-side security features, programmatic client applications for interfacing with appropriate application programming interfaces (APIs) over network 460, or other types of applications. Other applications may also include communication applications, such as email, texting, voice, social networking, and IM applications that allow a user to send and receive emails, calls, texts, and other notifications through network 460.

Network 460 may be a network which is internal to an organization, such that information may be contained within secure boundaries. In some embodiments, network 460 may be a wide area network such as the internet. In some embodiments, network 460 may be comprised of direct physical connections between the devices. In some embodiments, network 460 may represent communication between different portions of a single device (e.g., a communication bus on a motherboard of a computation device).

Network 460 may be implemented as a single network or a combination of multiple networks. For example, in various embodiments, network 460 may include the Internet or one or more intranets, landline networks, wireless networks, and/or other appropriate types of networks. Thus, network 460 may correspond to small scale communication networks, such as a private or local area network, or a larger scale network, such as a wide area network or the Internet, accessible by the various components of system 400.

User device 410 may further include database 418 stored in a transitory and/or non-transitory memory of user device 410, which may store various applications and data (e.g., model parameters) and be utilized during execution of various modules of user device 410. Database 418 may store user information, model parameters, etc. In some embodiments, database 418 may be local to user device 410. However, in other embodiments, database 418 may be external to user device 410 and accessible by user device 410, including cloud storage systems and/or databases that are accessible over network 460 (e.g., on data server 470).

User device 410 may include at least one network interface component 417 adapted to communicate with data server 470 and/or model server 440. In various embodiments, network interface component 417 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Data Server 470 may perform some of the functions described herein. For example, data server 470 may store a training dataset including user information, etc. Data server 470 may provide data to user device 410 and/or model server 440. For example, training data may be stored on data server 470 and that training data may be retrieved by model server 440 while training a model stored on model server 440.

Model server 440 may be a server that hosts models described herein. Model server 440 may provide an interface via network 460 such that user device 410 may perform functions relating to the models as described herein (e.g., predicting a recommended conditional credit). Model server 440 may communicate outputs of the models to user device 410 via network 460. User device 410 may display model outputs, or information based on model outputs, via a user interface to user 450.

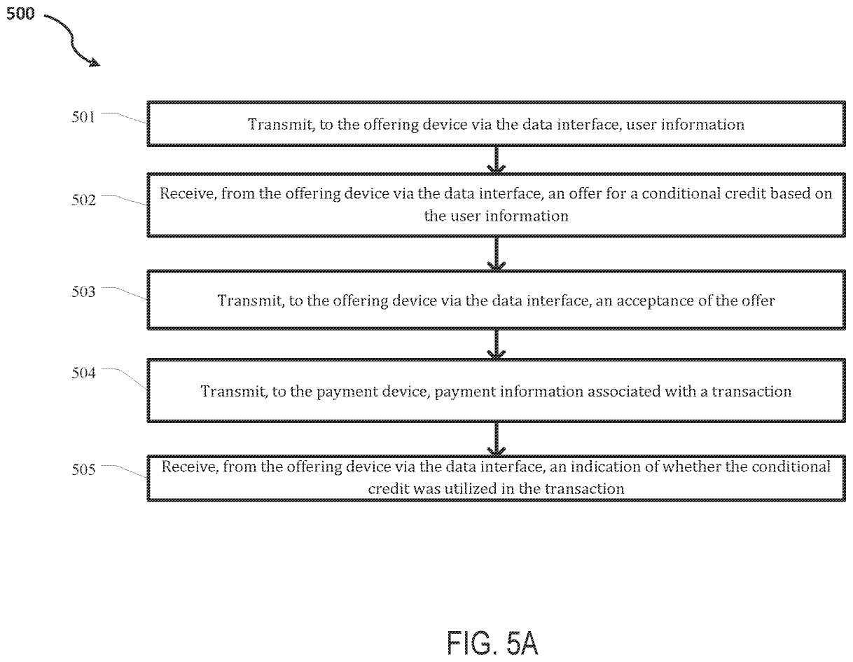

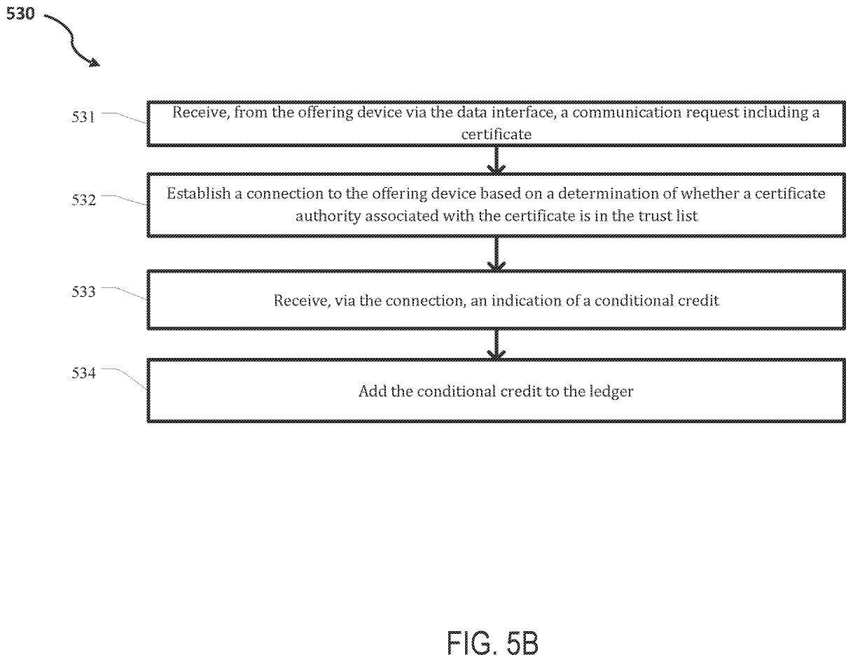

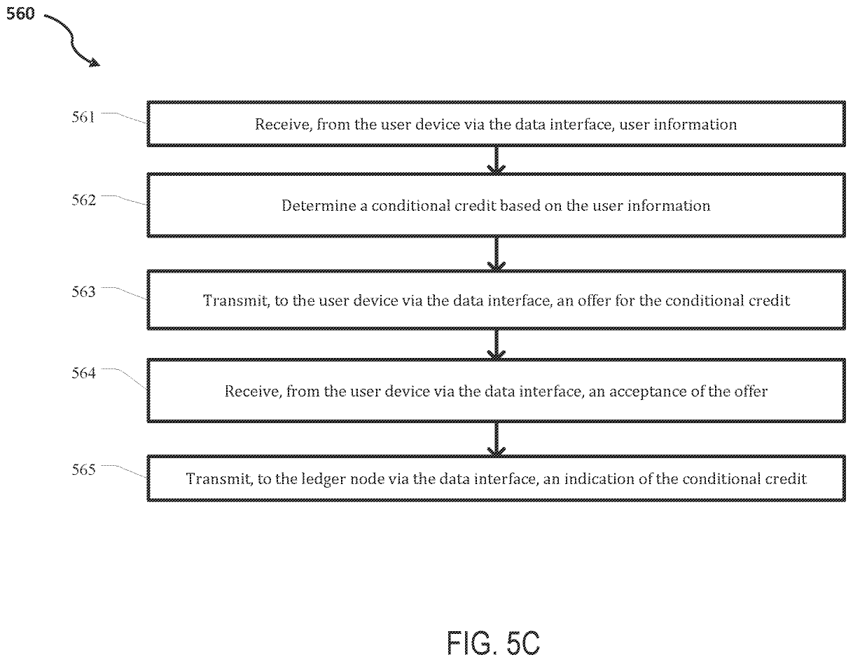

FIG. 5A is an example logic flow diagram, according to some embodiments described herein. One or more of the processes of method 500 may be implemented, at least in part, in the form of executable code stored on non-transitory, tangible, machine-readable media that when run by one or more processors may cause the one or more processors to perform one or more of the processes (e.g., computing device 200). In some embodiments, method 500 corresponds to the operation of the conditional credit module 230 that performs multi-party transactions.

As illustrated, the method 500 includes a number of enumerated steps, but aspects of the method 500 may include additional steps before, after, and in between the enumerated steps. In some aspects, one or more of the enumerated steps may be omitted or performed in a different order.

At step 501, a user device (e.g., the user device running application 105, computing device 200, user device 410, device 600, or device 615) transmits, to an offering device (e.g., credit issuer 140, computing device 200, user device 410, device 600, or device 615) via a data interface (e.g., data interface 215, network interface 417), user information. In some embodiments, the user information includes at least one of: historical activities data, sensor data, location data, or user-specific identifying data. For example, historical activities data may include previous purchased, behavior in other applications on the user device, etc. Sensor data may include camera, microphone, or other sensor data. Location data may include GPS location including current location and historical locations. User-specific identifying data may include information such as a user's age, gender, employment information, etc.

At step 502, the user device receives, from the offering device via the data interface, an offer for a conditional credit based on the user information. In some embodiments, the offer for the conditional credit includes one or more criteria. The one or more criteria may include one or more of: a timing criteria, a location criteria, or a purchase-type criteria. For example, the timing criteria may place a time limit on when the credit may be utilized (e.g., within the next 5 days), or may limit the usage to a particular time of day, a particular date (e.g., a certain holiday), etc. The location criteria may include a particular geographical area such as a city, county, state, within a national park, etc. The purchase-type criteria may limit the credit usage for particular stores, for purchasing particular types of items (e.g., healthcare-related items, food items, etc.).

At step 503, the user device transmits, to the offering device via the data interface, an acceptance of the offer. In some embodiments, the user device may receive, from a ledger node via the data interface, an indication of a ledger status associated with the conditional credit. In this way, the user device may display via a user interface to the user that the conditional credit is available, and that display may be updated based on usage of the conditional credit.

At step 504, the user device transmits, to a payment device (e.g., point of sale 120), payment information associated with a transaction.

At step 505, the user device receives, from the offering device via the data interface, an indication of whether the conditional credit was utilized in the transaction. The indication of whether the conditional credit was utilized in the transaction may be negative based on the one or more criteria not being met by the transaction, or positive based on the one or more criteria being met by the transaction.

FIG. 5B is an example logic flow diagram, according to some embodiments described herein. One or more of the processes of method 530 may be implemented, at least in part, in the form of executable code stored on non-transitory, tangible, machine-readable media that when run by one or more processors may cause the one or more processors to perform one or more of the processes (e.g., computing device 200). In some embodiments, method 530 corresponds to the operation of the conditional credit module 230 that performs multi-party transactions.

As illustrated, the method 530 includes a number of enumerated steps, but aspects of the method 530 may include additional steps before, after, and in between the enumerated steps. In some aspects, one or more of the enumerated steps may be omitted or performed in a different order.

At step 531, a ledger node (e.g., the user device running application 105, computing device 200, user device 410, device 600, or device 615) receives, from an offering device (e.g., credit issuer 140, computing device 200, user device 410, device 600, or device 615) via a data interface (e.g., data interface 215, network interface 417), a communication request including a certificate.

At step 532, the ledger node establishes a connection to the offering device based on a determination of whether a certificate authority associated with the certificate is in the trust list.

At step 533, the ledger node receives, via the connection, an indication of a conditional credit. In some embodiments, the conditional credit includes one or more criteria. The one or more criteria may include one or more of: a timing criteria, a location criteria, or a purchase-type criteria. For example, the timing criteria may place a time limit on when the credit may be utilized (e.g., within the next 5 days), or may limit the usage to a particular time of day, a particular date (e.g., a certain holiday), etc. The location criteria may include a particular geographical area such as a city, county, state, within a national park, etc. The purchase-type criteria may limit the credit usage for particular stores, for purchasing particular types of items (e.g., healthcare-related items, food items, etc.).

At step 534, the ledger node adds the conditional credit to the ledger.

In some embodiments, the ledger node may communicate with a payment processing device (e.g., payment processor 150) as a third party to a transaction between a user and a merchant. The ledger node may transmit, to the payment processing device, a status indication of the conditional credit. The ledger node may receive, from the payment processing device, an indication to modify the conditional credit. The ledger node may add a modification to of the conditional credit to the ledger based on the indication to modify. The modification may include an indication to reduce a credit amount. For example, when a user uses a portion of the available credit amount of a conditional credit, ledger node may reduce the amount available by updating the ledger.

In some embodiments, the ledger node may receive, from the payment processing device, transaction information (e.g., the merchant associated with the transaction, the amount, the item or service being purchased, etc.). The ledger node may transmit, to the payment processing device, an indication that the one or more criteria are met or not based on a comparison of the criteria with the transaction information.

In some embodiments, the ledger is a block-chain based ledger. The ledger node may transmit, to a second ledger node via the data interface, a second indication of the conditional credit. This may propagate the ledger information to the local ledgers of other ledger nodes.

FIG. 5C is an example logic flow diagram, according to some embodiments described herein. One or more of the processes of method 560 may be implemented, at least in part, in the form of executable code stored on non-transitory, tangible, machine-readable media that when run by one or more processors may cause the one or more processors to perform one or more of the processes (e.g., computing device 200). In some embodiments, method 560 corresponds to the operation of the conditional credit module 230 that performs multi-party transactions.

As illustrated, the method 560 includes a number of enumerated steps, but aspects of the method 560 may include additional steps before, after, and in between the enumerated steps. In some aspects, one or more of the enumerated steps may be omitted or performed in a different order.

At step 561, an offering device (e.g., credit issuer 140, computing device 200, user device 410, device 600, or device 615) receives, from a user device (e.g., the user device running application 105, computing device 200, user device 410, device 600, or device 615) via the data interface, user information. In some embodiments, the user information includes at least one of: historical activities data, sensor data, location data, or user-specific identifying data. For example, historical activities data may include previous purchased, behavior in other applications on the user device, etc. Sensor data may include camera, microphone, or other sensor data. Location data may include GPS location including current location and historical locations. User-specific identifying data may include information such as a user's age, gender, employment information, etc.

At step 562, the offering device determines a conditional credit based on the user information. In some embodiments, the conditional credit includes one or more criteria. The one or more criteria may include one or more of: a timing criteria, a location criteria, or a purchase-type criteria. For example, the timing criteria may place a time limit on when the credit may be utilized (e.g., within the next 5 days), or may limit the usage to a particular time of day, a particular date (e.g., a certain holiday), etc. The location criteria may include a particular geographical area such as a city, county, state, within a national park, etc. The purchase-type criteria may limit the credit usage for particular stores, for purchasing particular types of items (e.g., healthcare-related items, food items, etc.). The criteria may be determined by the offering device based on the user information. In some embodiments, a neural-network based model is provided the user information as an input, and the output of the neural-network based model indicates a recommended credit amount and/or criteria. The recommended credit amount and/or criteria may be determined from a preconfigured list, or may be adaptable within preset limits. For example, a company may provide bounds for credits that may be offered to customers (e.g., may offer a credit between $5 and $10, based on some criteria which may be flexible based on the neural-network based model).

At step 563, the offering device transmits, to the user device via the data interface, an offer for the conditional credit.

At step 564, the offering device receives, from the user device via the data interface, an acceptance of the offer.

At step 565, the offering device transmits, to a ledger node (e.g., the user device running application 105, computing device 200, user device 410, device 600, or device 615) via the data interface, an indication of the conditional credit. In some embodiments, the offering device receives a certificate from a certificate authority. The offering device may transmit, to the ledger node via the data interface, a communication request including the certificate. The offering device may establish a connection to the ledger node when the ledger node determines the certificate authority associated with the certificate is in the ledger node's trust list.

In some embodiments, the offering device may transmit, to the user device via the data interface, an indication of whether the conditional credit was utilized in a transaction.

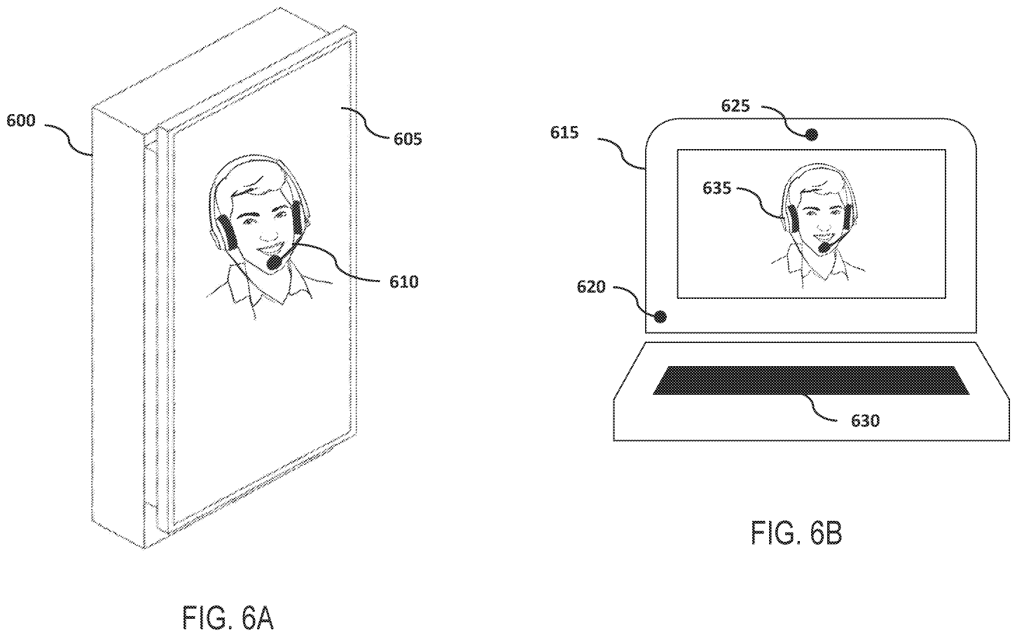

FIG. 6A is an exemplary device 600 with a digital avatar interface, according to some embodiments. Device 600 may be, for example, a kiosk that is available for use at a store, a library, a transit station, etc. Device 600 may display a digital avatar 610 on display 605. In some embodiments, a user may interact with the digital avatar 610 as they would a person, using voice and non-verbal gestures. Digital avatar 610 may interact with a user via digitally synthesized gestures, digitally synthesized voice, etc.

Device 600 may include one or more microphones, and one or more image-capture devices (not shown) for user interaction. Device 600 may be connected to a network (e.g., network 460). Digital Avatar 610 may be controlled via local software and/or through software that is at a central server accessed via a network. For example, an AI model may be used to control the behavior of digital avatar 610, and that AI model may be run remotely. In some embodiments, device 600 may be configured to perform functions described herein (e.g., via digital avatar 610). For example, device 600 may perform one or more of the functions as described with reference to computing device 200 or user device 410. For example, digital avatar 610 may provide recommendations to a user with an associated conditional credit. By interacting with digital avatar 610, a user may accept the use of a conditional credit in a purchase. For example, digital avatar 610 may tell a user that if they visit a particular store in the next two days, they can receive $20 off any purchase over $100, and may ask for the user to confirm the offer. If the offer is accepted, a corresponding conditional credit may be added to the ledger for the user with the appropriate criteria.

FIG. 6B is an exemplary device 615 with a digital avatar interface, according to some embodiments. Device 615 may be, for example, a personal laptop computer or other computing device. Device 615 may have an application that displays a digital avatar 635 with functionality similar to device 600. For example, device 615 may include a microphone 620 and image capturing device 625, which may be used to interact with digital avatar 635. In addition, device 615 may have other input devices such as a keyboard 630 for entering text.

Digital avatar 635 may interact with a user via digitally synthesized gestures, digitally synthesized voice, etc. In some embodiments, device 615 may be configured to perform functions described herein (e.g., via digital avatar 635). For example, device 615 may perform one or more of the functions as described with reference to computing device 200 or user device 410. For example, digital avatar 635 may provide recommendations to a user with an associated conditional credit. By interacting with digital avatar 635, a user may accept the use of a conditional credit in a purchase. For example, digital avatar 635 may tell a user that if they visit a particular store in the next two days, they can receive $20 off any purchase over $100, and may ask for the user to confirm the offer. If the offer is accepted, a corresponding conditional credit may be added to the ledger for the user with the appropriate criteria.

The devices described above may be implemented by one or more hardware components, software components, and/or a combination of the hardware components and the software components. For example, the device and the components described in the exemplary embodiments may be implemented, for example, using one or more general purpose computers or special purpose computers such as a processor, a controller, an arithmetic logic unit (ALU), a digital signal processor, a microcomputer, a field programmable gate array (FPGA), a programmable logic unit (PLU), a microprocessor, or any other device which executes or responds instructions. The processing device may perform an operating system (OS) and one or more software applications which are performed on the operating system. Further, the processing device may access, store, manipulate, process, and generate data in response to the execution of the software. For ease of understanding, it may be described that a single processing device is used, but those skilled in the art may understand that the processing device includes a plurality of processing elements and/or a plurality of types of the processing element. For example, the processing device may include a plurality of processors or include one processor and one controller. Further, another processing configuration such as a parallel processor may be implemented.

The software may include a computer program, a code, an instruction, or a combination of one or more of them, which configure the processing device to be operated as desired or independently or collectively command the processing device. The software and/or data may be interpreted by a processing device or embodied in any tangible machines, components, physical devices, computer storage media, or devices to provide an instruction or data to the processing device. The software may be distributed on a computer system connected through a network to be stored or executed in a distributed manner The software and data may be stored in one or more computer readable recording media.

The method according to the exemplary embodiment may be implemented as a program instruction which may be executed by various computers to be recorded in a computer readable medium. At this time, the medium may continuously store a computer executable program or temporarily store it to execute or download the program. Further, the medium may be various recording means or storage means to which a single or a plurality of hardware is coupled and the medium is not limited to a medium which is directly connected to any computer system, but may be distributed on the network. Examples of the medium may include magnetic media such as hard disk, floppy disks and magnetic tapes, optical media such as CD-ROMs and DVDs, magneto-optical media such as optical disks, and ROMs, RAMS, and flash memories to be specifically configured to store program instructions. Further, an example of another medium may include a recording medium or a storage medium which is managed by an app store which distributes application, a site and servers which supply or distribute various software, or the like.

Embodiments and the operations described in this specification can be implemented in digital electronic circuitry, or in computer software, firmware, or hardware, including the structures disclosed in this specification or in combinations of one or more of them. The operations can be implemented as operations performed by a data processing apparatus on data stored on one or more computer-readable storage devices or received from other sources. A data processing apparatus, computer, or computing device may encompass apparatus, devices, and machines for processing data, including by way of example a programmable processor, a computer, a system on a chip, or multiple ones, or combinations, of the foregoing. The apparatus can include special purpose logic circuitry, for example, a central processing unit (CPU), a field programmable gate array (FPGA) or an application-specific integrated circuit (ASIC). The apparatus can also include code that creates an execution environment for the computer program in question, for example, code that constitutes processor firmware, a protocol stack, a database management system, an operating system (for example an operating system or a combination of operating systems), a cross-platform runtime environment, a virtual machine, or a combination of one or more of them. The apparatus and execution environment can realize various different computing model infrastructures, such as web services, distributed computing and grid computing infrastructures.

A computer program (also known, for example, as a program, software, software application, software module, software unit, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A program can be stored in a portion of a file that holds other programs or data (for example, one or more scripts stored in a markup language document), in a single file dedicated to the program in question, or in multiple coordinated files (for example, files that store one or more modules, sub-programs, or portions of code). A computer program can be executed on one computer or on multiple computers that are located at one site or distributed across multiple sites and interconnected by a communication network.

Processors for execution of a computer program include, by way of example, both general- and special-purpose microprocessors, and any one or more processors of any kind of digital computer. Generally, a processor will receive instructions and data from a read-only memory or a random-access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data. A computer can be embedded in another device, for example, a mobile device, a personal digital assistant (PDA), a game console, a Global Positioning System (GPS) receiver, or a portable storage device. Devices suitable for storing computer program instructions and data include non-volatile memory, media and memory devices, including, by way of example, semiconductor memory devices, magnetic disks, and magneto-optical disks. The processor and the memory can be supplemented by, or incorporated in, special-purpose logic circuitry.

Mobile devices can include handsets, user equipment (UE), mobile telephones (for example, smartphones), tablets, wearable devices (for example, smart watches and smart eyeglasses), implanted devices within the human body (for example, biosensors, cochlear implants), or other types of mobile devices. The mobile devices can communicate wirelessly (for example, using radio frequency (RF) signals) to various communication networks (described below). The mobile devices can include sensors for determining characteristics of the mobile device's current environment. The sensors can include cameras, microphones, proximity sensors, GPS sensors, motion sensors, accelerometers, ambient light sensors, moisture sensors, gyroscopes, compasses, barometers, fingerprint sensors, facial recognition systems, RF sensors (for example, Wi-Fi and cellular radios), thermal sensors, or other types of sensors. For example, the cameras can include a forward- or rear-facing camera with movable or fixed lenses, a flash, an image sensor, and an image processor. The camera can be a megapixel camera capable of capturing details for facial and/or iris recognition. The camera along with a data processor and authentication information stored in memory or accessed remotely can form a facial recognition system. The facial recognition system or one-or-more sensors, for example, microphones, motion sensors, accelerometers, GPS sensors, or RF sensors, can be used for user authentication. To provide for interaction with a user, embodiments can be implemented on a computer having a display device and an input device, for example, a liquid crystal display (LCD) or organic light-emitting diode (OLED)/virtual-reality (VR)/augmented-reality (AR) display for displaying information to the user and a touchscreen, keyboard, and a pointing device by which the user can provide input to the computer. Other kinds of devices can be used to provide for interaction with a user as well; for example, feedback provided to the user can be any form of sensory feedback, for example, visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments can be implemented using computing devices interconnected by any form or medium of wireline or wireless digital data communication (or combination thereof), for example, a communication network. Examples of interconnected devices are a client and a server generally remote from each other that typically interact through a communication network. A client, for example, a mobile device, can carry out transactions itself, with a server, or through a server, for example, performing buy, sell, pay, give, send, or loan transactions, or authorizing the same. Such transactions may be in real time such that an action and a response are temporally proximate; for example an individual perceives the action and the response occurring substantially simultaneously, the time difference for a response following the individual's action is less than 1 millisecond (ms) or less than 1 second(s), or the response is without intentional delay taking into account processing limitations of the system.

Examples of communication networks include a local area network (LAN), a radio access network (RAN), a metropolitan area network (MAN), and a wide area network (WAN). The communication network can include all or a portion of the Internet, another communication network, or a combination of communication networks. Information can be transmitted on the communication network according to various protocols and standards, including Long Term Evolution (LTE), 5G, I6 802, Internet Protocol (IP), or other protocols or combinations of protocols. The communication network can transmit voice, video, biometric, or authentication data, or other information between the connected computing devices.

Features described as separate implementations may be implemented, in combination, in a single implementation, while features described as a single implementation may be implemented in multiple implementations, separately, or in any suitable sub-combination. Operations described and claimed in a particular order should not be understood as requiring that the particular order, nor that all illustrated operations must be performed (some operations can be optional). As appropriate, multitasking or parallel-processing (or a combination of multitasking and parallel-processing) can be performed.

Although the exemplary embodiments have been described above by a limited embodiment and the drawings, various modifications and changes can be made from the above description by those skilled in the art. For example, even when the above-described techniques are performed by different order from the described method and/or components such as systems, structures, devices, or circuits described above are coupled or combined in a different manner from the described method or replaced or substituted with other components or equivalents, the appropriate results can be achieved. It will be understood that many additional changes in the details, materials, steps and arrangement of parts, which have been herein described and illustrated to explain the nature of the subject matter, may be made by those skilled in the art within the principle and scope of the invention as expressed in the appended claims.

What is claimed is:

1. A user device, comprising:
a memory that stores a plurality of processor executable instructions;
a data interface in communication with an offering device and a payment device; and
one or more hardware processors that read and execute the plurality of processor-executable instructions from the memory to perform operations comprising:
transmitting, to the offering device via the data interface, user information.
receiving, from the offering device via the data interface, an offer for a conditional credit based on the user information;
transmitting, to the offering device via the data interface, an acceptance of the offer;
transmitting, to the payment device, payment information associated with a transaction; and
receiving, from the offering device via the data interface, an indication of whether the conditional credit was utilized in the transaction.

2. The user device of claim 1, wherein the user information includes at least one of: historical activities data, sensor data, location data, or user-specific identifying data.

3. The user device of claim 1, the operations further comprising:
receiving, from a ledger node via the data interface, an indication of a ledger status associated with the conditional credit.

4. The user device of claim 1, wherein the offer for the conditional credit includes one or more criteria.

5. The user device of claim 4, wherein the one or more criteria include at least one of: a timing criteria, a location criteria, or a purchase-type criteria.

6. The user device of claim 4, wherein the indication of whether the conditional credit was utilized in the transaction is negative based on the one or more criteria not being met by the transaction.

7. The user device of claim 4, wherein the indication of whether the conditional credit was utilized in the transaction is positive based on the one or more criteria being met by the transaction.

8. A ledger node comprising:
a memory that stores a ledger, a trust list, and plurality of processor executable instructions;
a data interface in communication with an offering device; and
one or more hardware processors that read and execute the plurality of processor-executable instructions from the memory to perform operations comprising:
receiving, from the offering device via the data interface, a communication request including a certificate;
establishing a connection to the offering device based on a determination of whether a certificate authority associated with the certificate is in the trust list;
receiving, via the connection, an indication of a conditional credit; and
adding the conditional credit to the ledger.

9. The ledger node of claim 8, the operations further comprising:
transmitting, to a payment processing device, a status indication of the conditional credit;
receiving, from the payment processing device, an indication to modify the conditional credit; and
adding a modification to of the conditional credit to the ledger based on the indication to modify.

10. The ledger node of claim 9, wherein the indication to modify includes an indication to reduce a credit amount.

11. The ledger node of claim 8, wherein the conditional credit includes one or more criteria.

12. The ledger node of claim 11, wherein the one or more criteria include at least one of: a timing criteria, a location criteria, or a purchase-type criteria.

13. The ledger node of claim 12, the operations further comprising:
receiving, from a payment processing device, transaction information; and
transmitting, to the payment processing device, an indication that the one or more criteria are met based on the transaction information.

14. The ledger node of claim 12, the operations further comprising:
receiving, from a payment processing device, transaction information; and
transmitting, to the payment processing device, an indication that the one or more criteria are not met based on the transaction information.

15. The ledger node of claim 8, wherein the ledger is a blockchain-based ledger, the operations further comprising:
transmitting, to a second ledger node via the data interface, a second indication of the conditional credit.

16. An offering device, comprising:
a memory that stores a plurality of processor executable instructions;
a data interface in communication with a user device and a ledger node; and
one or more hardware processors that read and execute the plurality of processor-executable instructions from the memory to perform operations comprising:
receiving, from the user device via the data interface, user information.
determining a conditional credit based on the user information;
transmitting, to the user device via the data interface, an offer for the conditional credit;
receiving, from the user device via the data interface, an acceptance of the offer; and
transmitting, to the ledger node via the data interface, an indication of the conditional credit.

17. The offering device of claim 16, the operations further comprising:
transmitting, to the user device via the data interface, an indication of whether the conditional credit was utilized in a transaction.

18. The offering device of claim 16, wherein the offer for the conditional credit includes one or more criteria.

19. The offering device of claim 18, wherein the one or more criteria include at least one of: a timing criteria, a location criteria, or a purchase-type criteria.

20. The offering device of claim 16, the operations further comprising:
receiving a certificate from a certificate authority;
transmitting, to the ledger node via the data interface, a communication request including the certificate; and
establishing a connection to the ledger node.
